(19) United States
(12) Patent Application Publication
(10) Pub. No.: US 2010/0272955 A1
(43) Pub. Date: Oct. 28, 2010

(54) Low Cost Interior Wrap

(75) Inventors: Robert R. Chimelak, Warren, MI (US); Aaron S. Wisniewski, Plymouth, MI (US); Jerome Fisher, Birmingham, MI (US)

Correspondence Address: GIBSON & DERNIER LLP, 900 ROUTE 9 NORTH, SUITE 504, WOODBRIDGE, NJ, 07095, US

(73) Assignee: Faurecia Interior Systems U.S.A., Auburn Hills, MI (US)

(21) Appl. No.: 12/702,372

(22) Filed: Feb. 9, 2010

Related U.S. Application Data
(60) Provisional application No. 61/172,517, filed on Apr. 24, 2009.

(51) Int. Cl. B32B 3/10; B32B 3/26; B65H 81/00; B32B 38/10

(52) U.S. Cl. 428/138; 428/158; 428/159; 428/160; 156/185; 156/268; 156/257

(57) ABSTRACT

A bilaminate wrap and methods for its manufacture are disclosed, the wrap being useful for incorporation onto interior trim panels. The bilaminate wrap comprises a skin integrated with a foam layer made of a plastics material, most preferably a thermoplastic polyolefin. The plastics material permits thin constructions and the use of skiving to incorporate different profiles of variable thicknesses into the panels.

The application claims the benefit of Provisional Application No. 61/172,517 entitled “LOW COST INTERIOR WRAP”, filed Apr. 24, 2009, which is hereby expressly incorporated by reference herein.

### FIELD OF THE INVENTION

The present invention relates generally to the interior of vehicles and their method of manufacture, and more particularly, to decorative interior panels of the vehicle, such as may be disposed on a door, dashboard, seat, ceiling, sidewall, instrument panel, center console and other trim panels.

### BACKGROUND OF THE INVENTION

Automobile interiors typically have a decorative skin, such as fabric or leather, with an underlying support structure or substrate. Interposed between the skin and substrate is typically a cloth or mesh spacer. A significant drawback of the cloth or mesh spacer is that it is too weak to maintain its shape if parts are cut out, for example, various profiles. Because of this drawback, designers have limited aesthetic and functional design options available. For example, sharp edges or small radii in panels are avoided because the relatively weak cloth or mesh at corners becomes misshaped and compressed. Also, because of the compression, a panel using cloth spacers and having small radii exhibits a harder and less desirable feel.

Also, conventional interior panels are often thermoformed from relatively thick sheets. These panels are heavier and accordingly, material usage is greater and more expensive. Furthermore, a decorative skin made of thick plastic sheet does not allow the deployment of an airbag unless the decorative skin is weakened. However, when the decorative skin is scored, a witness line, known as “read-through,” can be observed opposite the side that was weakened, resulting in non-desirable aesthetics.

### SUMMARY OF THE INVENTION

In accordance with aspects of the present invention, a low cost interior wrap for vehicles and methods of manufacture are disclosed. The low cost interior wrap is especially suited for use as a decorative trim panel, such as may be disposed on a door, dashboard, seat, ceiling, sidewall, instrument panel, center console, etc., in passenger automobiles and trucks.

The wrap is comprised of a bilaminate made from a plastics material, preferably a thermoplastic polyolefin (TPO), thermoplastic polyurethane (TPU) or Poly vinly chloride (PVC). The bilaminate includes a foam layer integrated with a skin. The bilaminate may be advantageously cut and sewn to any desirable width and length, and comprises a skin thickness ranging from approximately 0.8 mm to 1.0 mm, more preferably from approximately 0.55 mm to 0.8 mm, and most preferably from approximately 0.3 mm to 0.55 mm. The foam layer may be skived to hold virtually any desirable profile. The bilaminate is preferably wrapped onto a substrate and adhered by an adhesive, the substrate typically being made of plastic. This wrap is then incorporated into a vehicle as a panel or trim. The panel may also have a protective airbag affixed thereto.

Methods of producing a bilaminate for an interior trim panel are also disclosed in further aspects of the invention. One such method commences with receiving a thin outer skin and a foam layer. The outer skin is adhered to the foam layer and the foam layer is skived to suit a desired profile. It can be appreciated that the foam layer can also be skived prior to adhering it to the outer skin. Based on measurements associated with a selected profile, a skiving machine with an appropriate blade is employed for this procedure.

Another aspect relates to a method of manufacturing an interior trim panel employing the bilaminate. The method comprises receiving a substrate and a bilaminate material, applying adhesives and adhering the bilaminate to the substrate. The bilaminate comprises a foam layer that is skived into a desired profile based on measurements related to the profile. For example, the foam layer can be skived to a thickness that matches an area interposed between the thin outer skin and the substrate. As the foam layer is made up of a non-porous material it can hold a shape regardless of the thickness of the material removed from it due to skiving.

### BRIEF DESCRIPTION OF THE DRAWINGS

FIG. 1 is a schematic depicting the skin, foam layer and substrate construction in accordance with one or more embodiments of the present invention.

FIG. 2 is a schematic depicting the limitations of skiving fabrics, as compared with the bilaminate having various profiles skived into the foam layer.

FIG. 3 is a schematic depicting the limitations of skiving fabrics, as compared with the bilaminate.

FIG. 4 is a flow diagram of a process to produce the bilaminate in accordance with an aspect of the invention.

FIG. 5 is a flow diagram of a process to produce the bilaminate in accordance with another aspect of the invention.

FIG. 6 is a flow diagram of a skiving process in accordance with one or more aspects of the present invention.

FIG. 7 is a flow diagram of one example of a process of manufacturing the bilaminate in accordance with the present invention.

FIG. 8 is a flow diagram of another example of a process of manufacturing the bilaminate in accordance with the present invention.

FIG. 9 is another flow diagram detailing a sub process involved in the manufacture of the interior trim panel.

FIG. 10 details another methodology of obtaining a finished interior trim panel.

### DETAILED DESCRIPTION OF THE DRAWINGS

In the following description, for purposes of explanation, specific numbers, materials and configurations are set forth to provide a thorough understanding of the invention. It will be apparent to one having ordinary skill in the art that the invention may be practiced without these specific details. In some instances, well-known features may be omitted or simplified so as not to obscure the present invention.

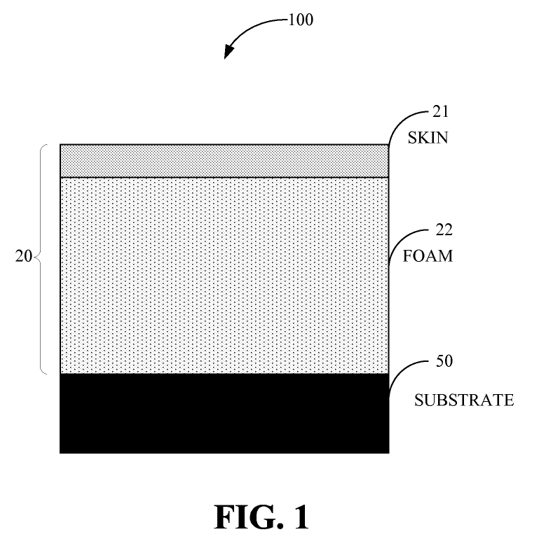

Turning now to the drawings, FIG. 1 shows section view of an interior trim panel 100 employing the bilaminate 20 of an embodiment of the present invention, comprising a thin outer skin (or foil) 21, a foam layer 22 and a substrate 50. The bilaminate 20 can be a plastics material, preferably a TPO (Thermoplastic polyolefin), TPU (Thermoplastic polyurethane) or PVC (Poly vinyl chloride) plastics material. The skin and foam layer are formed from the plastics material and are integrated as the bilaminate 20. In a further aspect, the foam layer 22 can comprise an open or closed-cell, non-porous structure, which results in a less absorbent, firmer material that permits skiving various profiles into it as detailed infra. The bilaminate 20 is attached to the substrate 50, for example, using an adhesive. The substrate 50 forms the plastic base for the structure of an interior trim panel.

Because the skin 21 of the bilaminate 20 is thin and the foam layer 22 may be skived to virtually any shape, as discussed above, an advantage is that designers will have more design flexibility in that small radii can be formed on panels while maintaining desirable tactility and requisite support. In addition, lighter panels can be manufactured, leading to cost savings for materials.

Additionally, the thinner skin 21 of embodiments of the present invention further facilitates eliminating the step of weakening the skin 21, for e.g., a stress concentrator providing a path for the initiation and propagation of a tear when used in conjunction with a protective airbag. Improved aesthetics result because no read-through witness lines can be observed on the resultant decorative trim or panel. Other advantages include that topcoats and other surface treatments may be used on the skin 21 to provide greater tactile and aesthetic characteristics.

Another design advantage made possible through aspects of the present invention is that the foam layer 22 can comprise a closed-cell or non-porous structure, which results in a less absorbent material. This permits the use of less adhesive when wrapping the bilaminate 20 to the substrate 50 during manufacturing. In sum, embodiments of the present invention may thus be able to provide a cost-effective alternative to leather or fabric.

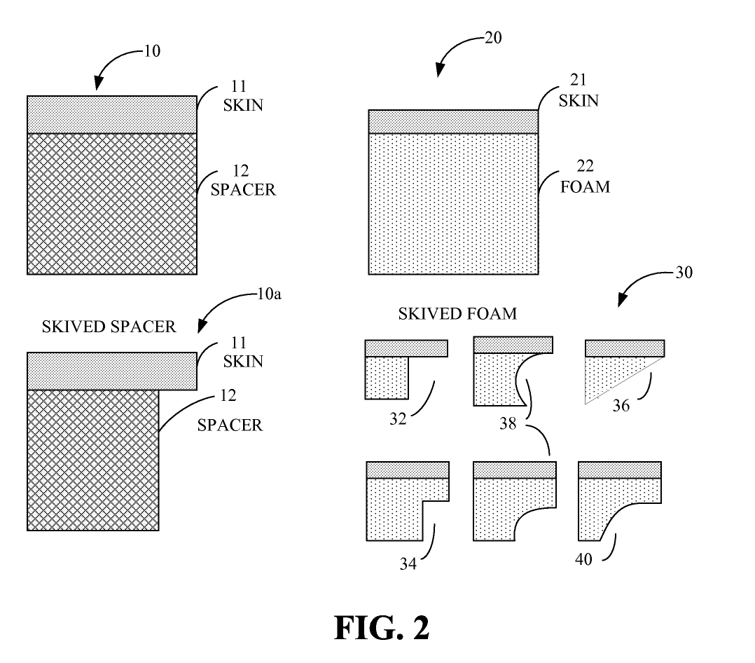

FIG. 2 shows a schematic diagram comparing various bilaminates with different characteristics. For example, characteristics of a bilaminate 10 including a spacer fabric 12 are compared with the characteristics of the bilaminate 20. The bilaminate 10 is made up of skin 11 and spacer fabric 12 while the bilaminate 20 comprises a decorative layer or skin or foil 21 and a foam layer 22. The skin 21 is approximately one-half as thick as the skin 11 of the bilaminate 10. The thickness of the skin layer 21 for the bilaminate 20 can range from approximately 0.3 mm to 1.0 mm and most preferably from approximately 0.3 mm to 0.55 mm. The thickness of the foam layer 22 can vary from approximately 0.25 mm to 3.0 mm, although the foam layer 22 can be significantly thicker where the application demands. Accordingly, the bilaminate 20 can be as thin as 0.55 mm. As mentioned herein, the foam layer 22 of the bilaminate 20 is a closed cell, non-porous material, while, the bilaminate 10 has a cloth spacer 12 (fabric layer) which is both thicker and weaker. Additionally, the skin 11 of the thermoformed layer of the bilaminate 10 is also approximately 1.0 mm thick.

In accordance with one aspect of the present invention, the foam layer 22 can be skived to any desirable profile such as profiles 30 while maintaining its shape and strength. This is not possible with the spacer fabric 12 of the bilaminate 10, due to its nature. The spacer fabric 12 is woven together as a mesh at the top and bottom, with the strands connected together at the center. Therefore, the spacer fabric can either be skived off as a whole as shown at 10a or it should be left completely intact. It cannot be partially skived to a profile, as it weakens the strands and hence the spacer will not hold to shape.

In contrast, the foam layer 22 of the bilaminate can be skived into different profiles 30. In a further aspect, the measurements of the profile to be skived into the foam layer 22 can be obtained and the foam layer 22 can be skived in accordance with such measurements. Different profiles including square 32, rectangular 34, angled 36, parabolic 38, and other variable shaped 40 contours are shown, although the foam 22 may be skived to achieve virtually any desirable shape or profile. The various profiles in the foam layer 22 can be obtained by using different blades on a skiving/milling machine. As the foam material 22 is non-porous and does not rely on the weaving nature for its strength, it holds the same firmness regardless of the profile/thickness cut into it. This results in greater flexibility for designers as they can obtain parts with smaller radii while maintaining the firmness with desirable tactility.

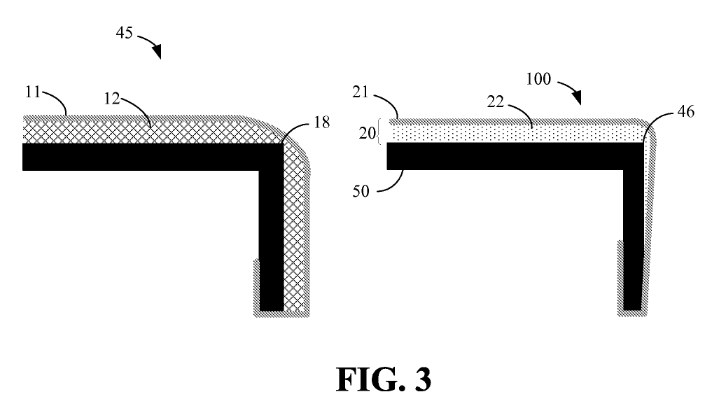

FIG. 3 shows another comparison of different spacer materials used to create the interior trim panels. For example, the foam layer 22 in accordance with the present invention can include areas of relatively lesser thickness, for example, a thin foam layer 22 is shown supporting a small radius. Here, the thin foam layer 22 is skived into a profile matching the area interposed between the substrate 50 and the skin 21. A smooth transition and soft feel results as the thinner foam layer 22 is able to follow the contour 46 with a smaller bend radius. This facilitates easier hand wrapping of the bilaminate 20 to the substrate 50. This is in contrast to the structure 45, wherein the cloth spacer 12 becomes compressed and cannot support the area between the skin 11 and the substrate 15. This is because the cloth spacer 12 cannot be partially skived to suit the corner 18. Consequently, a much larger bend radius is formed resulting in a harder and less desirable finish. Another option with the cloth spacer 12 would be to skive it completely thereby adhering the skin 11 to the substrate 15. This process also fails to return a satisfactory finish as the resulting structure would be too hard, thereby resulting in less desirable feel. Accordingly, the present invention allows the design of structures with smaller bend radii, which are stronger, lighter, more aesthetically pleasing, and more pleasing to the touch.

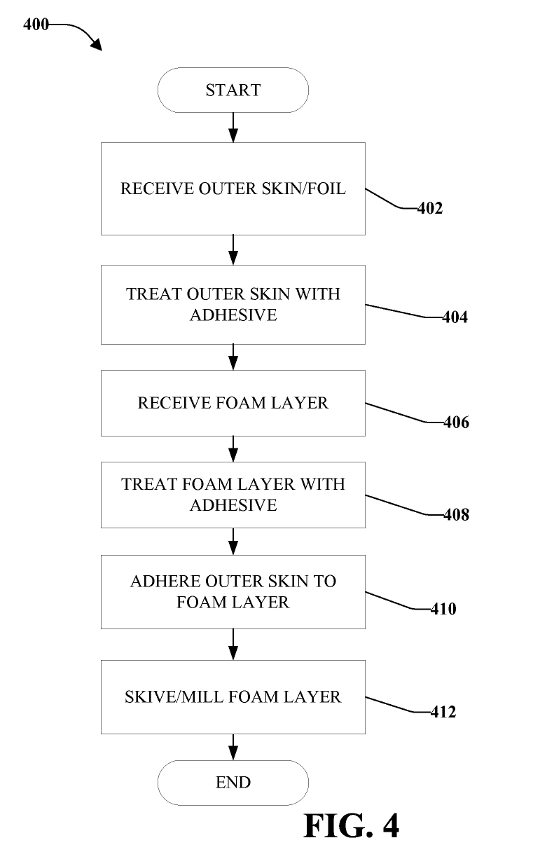

FIG. 4 is a flow diagram that details a process 400 to produce the bilaminate 20 in accordance with an aspect of the invention. The procedure 400 begins at 402 wherein an outer skin/foil roll is received. Although by the way of illustration and not limitation, it is disclosed that a skin/foil roll is received, it can be understood that skin cut into different contours, for example, using a cutting table, can also be used in this process. In accordance with an aspect of the invention, the outer skin is made of TPO, TPU or PVC and has a thickness varying from 0.3 mm to 1.0 mm and most preferably from approximately 0.3 mm to 0.55 mm. Hence it is thinner than cloth/leather skins conventionally used for interior trim panels. At 404, the outer skin is treated with adhesive on its back surface. In a more detailed aspect the adhesive can be a water based adhesive, in which case, the adhesive would have to be dried prior to adhering the skin to a foam layer. At 406, a foam layer to be adhered to the skin is received. As mentioned supra, the foam layer can be a closed cell, non-porous material so that it does not absorb a large quantity of adhesive. Step 408 shows the process of delivering adhesive to the surface of the foam layer (for example, by spraying, pouring, depositing, etc.), prior to adhering it to the outer skin layer. As mentioned earlier, based on the type of adhesive used, the process 400 may comprise an optional step of drying the adhesive on the foam layer prior to adhering it to the outer skin. At 410, the foam layer is adhered to the outer skin to form a bilaminate. Based on the thickness of the foam layer, the thickness of the bilaminate can vary from 3 mm to 10 mm. At 412, the foam layer is skived in accordance with a desired profile. The foam layer can either be skived completely or partially to suit the profile.

Various contours can be milled/skived into the foam using different blades on the skiving machine. If, the outer skin is received as a foil roll at step 402, different templates can be cut from the resulting bilaminate and sewn together to fit a desired part. On the contrary, if various templates of the outer skin are received at step 402, they may be sewn together after skiving the foam at 412 so that the resulting sewn pieces maintain a uniform profile. In this case, the foam can be partially skived with gradually varying thickness from an outer edge to the inner surface. The plastics material permits thin constructions and the use of skiving to incorporate various profiles of variable thicknesses into the panels, resulting in reduced manufacturing costs, an increase in the amount of design possibilities, more attractive aesthetics and improved tactile characteristics.

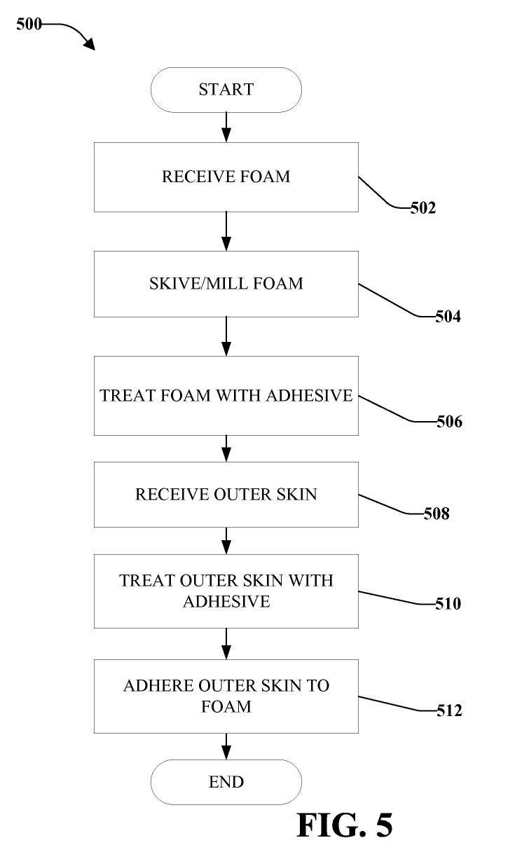

FIG. 5 is a flow chart detailing a process 500 of producing the bilaminate in accordance with another aspect of the invention. The process 500 begins at 502 wherein the foam to be used in the bilaminate is received. At 504, the foam is skived to suit a desired profile. At 506, the foam is treated with an adhesive and based on the type of adhesive used, an optional step of drying the adhesive may be included into the process 500. At 508, the outer skin making up the bilaminate is received. The skin can be received either as a roll or cut into one or more templates. At 510, the skin is also treated with the adhesive and at 512, the outer skin/foil is adhered to the skived foam. As mentioned supra, if the outer skin is received in the form of different templates that should be sewn together, the foam can be skived to suit a profile wherein its thickness gradually varies from the outer edges to an inner surface so that the resulting sown pieces of the bilaminate maintain a uniform profile. The template pieces may be sewn together either solely with a functional seam or they can be sewn together to include a functional and a decorative seam in accordance with different aspects.

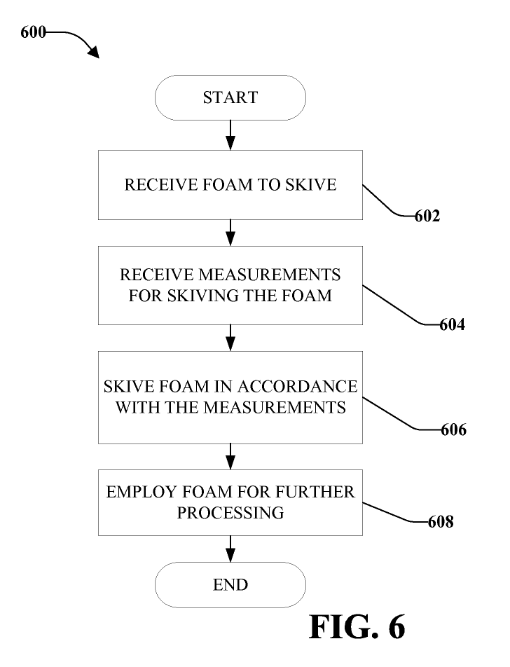

FIG. 6 illustrates another flow diagram detailing the process 600 of skiving the foam in accordance with an aspect of the invention. The process 600 commences with receiving the foam to be skived as shown at 602. As detailed supra, the foam may be adhered to the outer skin of the bilaminate. At 604, the measurements relating to a desired profile to be milled/skived into the foam are obtained. Different profiles can be skived into the foam and since it is a non-porous, closed cell material, its firmness can be maintained regardless of the thickness of the material that remains upon skiving. Additionally, skiving the foam in accordance with the desired profile facilitates forming contours of smaller radii on the trim panels. At 606, the desired profile is skived into the foam. A skiving machine with a blade that skives the desired profile may be used for this step. Thus, a foam/bilaminate of varying thickness is obtained to suit a profile. This foam may be further processed as shown at 608 by adhering to a substrate and/or outer skin for use in producing the interior trim panel.

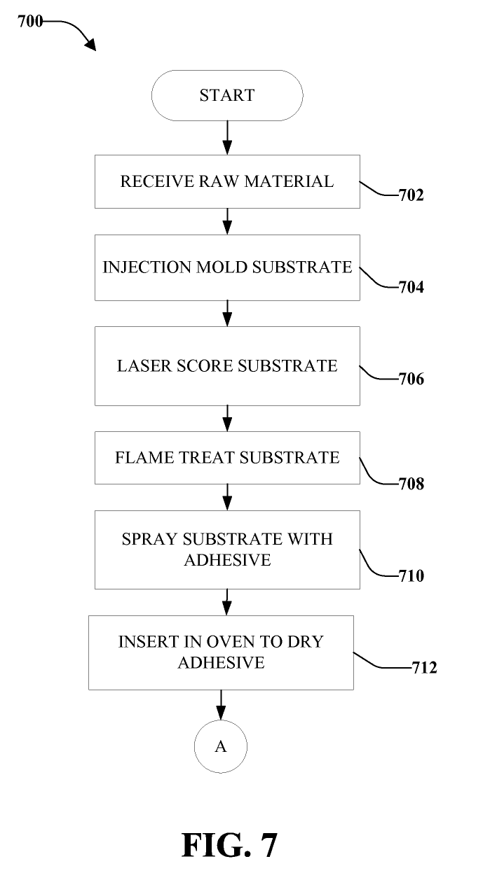

FIG. 7 is another flow chart 700 detailing some of the manufacturing steps involved in making an interior trim panel in accordance with the invention. More particularly, 700 details the steps involved in preparing the substrate material for producing the interior trim panel. The process flow begins at 702 with receiving raw material for the substrate from the supplier. The raw material is injection molded into a substrate that forms a structure for an interior trim panel as shown at 704. Based on the location of the trim panel in an interior, various optional steps can be involved in this process. For example, if the trim panel being produced is part of a door panel, then considerations such as air bag ejection etc. are not necessary. If the trim panel is part of an instrument panel, then the substrate has to be fashioned to facilitate ejection of the air bags when needed. Therefore, the substrate is weakened as shown at 706. For example, the substrate may be scored or perforated using a laser. When an air bag is deployed it can break through the plastic and tear through the outer skin/foil. Subsequently, the substrate material is optionally flame treated at 708. This step is contemplated for materials such as olefinic substrates. According to this procedure, the top layer of the plastic substrate is burnt to allow it to be firmly bonded with other materials such as the foam layer, outer skin etc. The substrate is then sprayed with an adhesive as shown at 710 or the adhesive can be spread on the substrate with a roller. Based on the type of adhesive used, the substrate may be inserted into an oven at 712 to dry the adhesive. The substrate is now ready to be bonded to a material to produce an interior trim panel. In accordance with different aspects, the substrate may be bonded to an outer skin or it can be bonded to a foam layer skived to suit a desired profile. The connector A leads to further steps of processing the substrate as detailed infra.

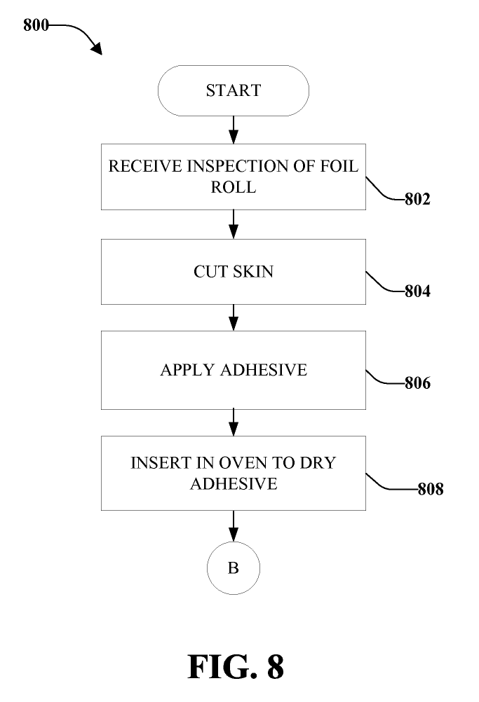

FIG. 8 details another sub-process involved in producing the trim panel in accordance with an aspect of the invention. The flow chart 800 details the steps involved in preparing the outer skin to be used for the trim panel. The flow chart begins with receiving the inspection of the foil/outer skin roll as show at 802. In an aspect of the invention, the outer skin/foil roll may be bonded to a foam layer thereby forming a bilaminate. In a more detailed aspect, the foam layer of the bilaminate can be skived in accordance with a predetermined profile for the trim panel to be made. The outer skin is cut into the requisite templates on, for example, a cutting table as shown at 804 and an adhesive is applied at 806. The adhesive can be sprayed onto the outer skin or it may be applied with a roller. As mentioned supra, various adhesives may be a water based adhesive. In this case, the foil which is treated with the adhesive is placed in an oven at 808 to dry it and subsequently processed further to form a desired interior trim panel in accordance with an aspect of the invention as shown by connector B.

If at 802, the outer skin alone was received, another process of adhering the foam layer to the foil as outlined supra can follow step 808. For example, the outer skin/foil can be bonded to the foam layer after it has been dried at 808 and the foam layer can be suitably skived to facilitate sewing the various foil pieces together. It at 802 a bilaminate in accordance with the invention was received, such bilaminate is further processed after step 808 with the substrate to produce an interior trim panel.

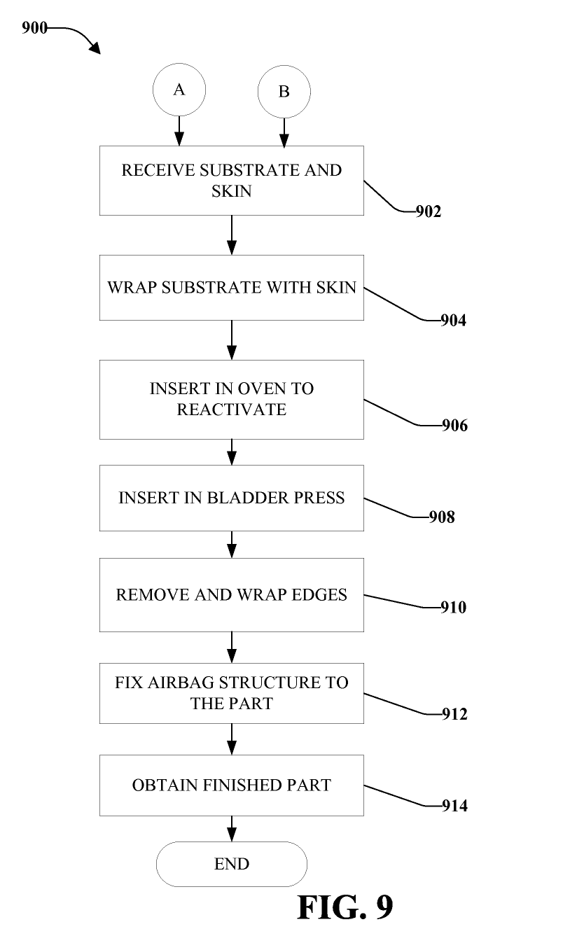

FIG. 9 is another flow diagram detailing a sub process involved in the manufacture of the interior trim panel. The procedure begins at 902 wherein the substrate from the process detailed in FIG. 7 and the skin prepared according to the procedure of FIG. 8 are received. At 904 the substrate is wrapped with the outer skin/foil/bilaminate by placing it in contact with the foil. A heat gun can be employed for firmly wrapping the substrate with the skin/bilaminate. If the bilaminate comprises a foam layer skived to suit the contours on the substrate, hand wrapping the bilaminate is easier and results in a structure with smooth finish but which maintains requisite firmness. At 906, the substrate with the skin wrapped onto it is placed in an oven to activate the entire adhesive. It is then moved to a bladder press as shown at 908 which creates a pressure to firmly bond the skin to the substrate. Upon removal from the bladder press, the extraneous edges of the skin that may be loose are firmly wrapped to the substrate using a heat gun as shown at 910. If the trim panel resulting from this procedure is meant for a part of the interior such as an instrument panel, an optional step of fitting the resulting structure with air bags follows as shown at 912 and the finished part with or without the air bags is obtained at 914. The process subsequently terminates on the end block.

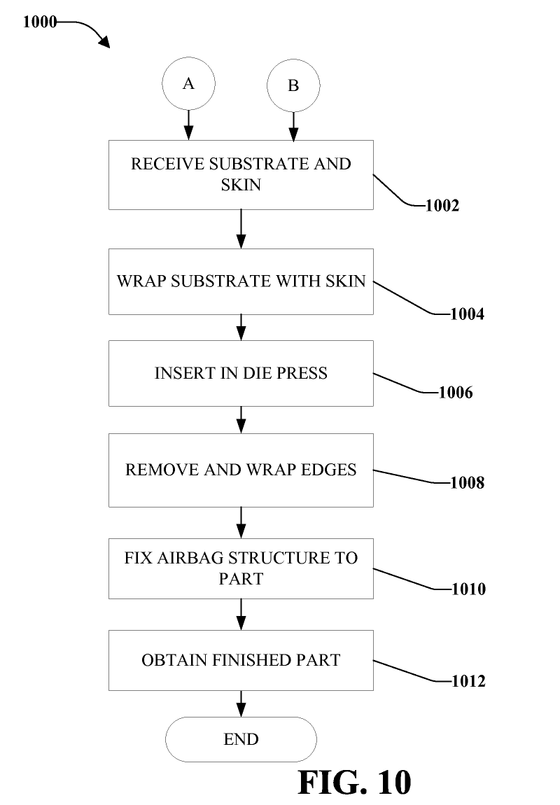

FIG. 10 details another methodology 1000 of obtaining a finished interior trim panel. This is similar to the method detailed above in FIG. 9, however, the step of firmly bonding the skin/bilaminate to the substrate is carried out using a die press. Accordingly, the method begins at 1002 wherein the substrate from the process detailed in FIG. 7 and the outer skin/foil/bilaminate treated according to the process shown in FIG. 8 are received. The substrate is wrapped with the outer skin/foil/bilaminate as shown at 1004. At 1006, the substrate with the skin wrapped onto it is inserted into a die press to firmly bond them together. Upon removal from the die press, the extraneous edges of the skin that may be loose are firmly wrapped to the substrate using, for example, a heat gun as shown at 1008. If the trim panel resulting from this procedure is meant for a part of the interior such as an instrument panel, an optional step of fitting the resulting structure with air bags follows as shown at 1008 and the finished part with or without the air bags is obtained at 1010. The process subsequently terminates on the end block.

It is can be noted that the bilaminate obtained from various procedures detailed herein can be cut and sown with other bilaminates, or other structures, for example, compact sheet materials, to form integrated interior panels, with or without skiving of the foam layer. Skiving the foam layer as described herein also allows easier hand wrapping of an edge, saving additional time and expense as well as lower scrap rates because less product is in non-conformance with engineering specifications. It is important to note that these steps for different procedures detailed herein do not recite the use of a scoring process on the bilaminate but rather only the substrate material is weakened to facilitate ejection of the airbags. Further surface treatment is contemplated for olefinic substrates.

Although preferred embodiments of the invention are disclosed for illustrative purposes, those skilled in the art will appreciate that many additions, modifications, and substitutions are possible without departing from the scope and spirit of the invention.

1. An interior panel, comprising:
a thin outer skin; and
a skived foam layer, wherein the foam layer is skived into a desirable profile of varying thickness.

2. The interior panel of claim 1, further comprising a substrate supporting the foam layer.

3. The interior panel of claim 2, wherein the varying thickness of the foam layer matches an area interposed between the thin outer skin and the substrate.

4. The interior panel of claim 2, wherein the substrate comprises perforations to facilitate deployment of airbags.

5. The interior panel of claim 1, wherein one or more of the thin outer skin or the foam layer is made from a plastics material.

6. The interior panel of claim 1, wherein the plastics material is selected from a group comprising of TPO (Thermoplastic polyolefin), TPU (Thermoplastic polyurethane) or Poly vinyl chloride (PVC).

7. The interior panel of claim 1, wherein a thickness of the thin outer skin ranges from 0.3 millimeters to 0.55 millimeters.

8. The interior panel of claim 1, wherein the thickness of the foam layer ranges from approximately 0.25 millimeters to 3.0 millimeters.

9. A decorative interior panel for a vehicle comprising:
a bilaminate comprising a thin outer skin integrated with a skived foam layer of a variable thickness; and
a substrate supporting the foam layer.

10. The decorative interior panel of claim 9, wherein the bilaminate is made from one of TPO (Thermoplastic polyolefin) or TPU (Thermoplastic polyurethane).

11. The decorative interior panel of claim 9, wherein a thickness of the thin outer skin ranges from 0.3 millimeters to 0.55 millimeters.

12. The decorative interior panel of claim 9, wherein the thickness of the foam layer varies from approximately 0.25 millimeters to 3.0 millimeters.

13. The decorative interior panel of claim 9, wherein the substrate comprises perforations.

14. The decorative interior panel of claim 13, wherein the substrate is an olefin based substrate.

15. The decorative panel of claim 9, wherein the variable thickness of the foam layer suits a desirable profile.

16. The decorative panel of claim 9, wherein the foam layer comprises a closed or open cell, non-porous material.

17. A method of manufacturing an interior trim panel, comprising:
receiving a roll of bilaminate comprising a thin outer skin and a foam layer;
skiving the foam layer to a varying thickness that fits a desired profile; and
wrapping a substrate with the bilaminate.

18. The method of claim 17, further comprising weakening the substrate to facilitate deployment of airbags.

19. The method of claim 17, further comprising delivering adhesive to the foam layer of the bilaminate prior to the step of wrapping.

20. The method of claim 17, further comprising drying the adhesive delivered to the foam layer of the bilaminate prior to the step of wrapping.

21. The method of claim 17, further comprising delivering adhesive to the substrate prior to the step of wrapping.

22. The method of claim 21, further comprising drying the adhesive delivered to the substrate prior to the step of wrapping.

23. A method of producing a bilaminate for an interior trim panel, comprising:
receiving a thin outer skin and a foam layer;
adhering the outer skin to the foam layer; and
skiving the foam layer to suit a desired profile such that the foam layer has variable thickness.

24. The method of claim 23 further comprising treating one or more of the thin outer skin or the foam layer with an adhesive.

25. The method of claim 23, further comprising employing a blade in a skiving machine based on the profile to be skived into the foam layer.

26. The method of claim 23, further comprising receiving measurements of the desired profile for skiving the foam layer.

27. A method of producing a bilaminate for an interior trim panel, comprising:
receiving a foam layer;
skiving a foam layer to suit a desired profiler of variable thickness; and
adhering the skived foam layer to an outer skin to be employed in the bilaminate.

28. The method of claim 27, further comprising the step of receiving measurements for skiving the foam layer.

29. A method of manufacturing an vehicle interior trim panel, comprising:
receiving a roll of bilaminate comprising a foil and a foam layer;
milling the foam layer to a variable thickness that fits a desired profile; and
handwrapping a substrate with the bilaminate.

30. The method of claim 29, further comprising scoring the substrate to facilitate ejection of airbags.
